(19) United States
(12) Patent Application Publication
(10) Pub. No.: US 2009/0207329 A1
(43) Pub. Date: Aug. 20, 2009

(54) LIQUID CRYSTAL DISPLAY

(75) Inventors: Yoshimizu Moriya, Mie (JP); Mutsumi Nakajima, Nara (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/294,058

(22) PCT Filed: Feb. 6, 2007
(86) PCT No.: PCT/JP2007/051983

§ 371 Date: Sep. 23, 2008

(30) Foreign Application Priority Data
Mar. 24, 2006 (JP) 2006-082603

(51) Int. Cl. G02F 1/1343

(52) U.S. Cl. 349/38

(57) ABSTRACT

A liquid crystal display includes a plurality of pixels arranged in a matrix array, each pixel including a liquid crystal capacitor which includes a pixel electrode subjected to switching by a top-gate type thin film transistor, a counter electrode opposing the pixel electrode, and a liquid crystal layer disposed therebetween, and a first storage capacitor and a second storage capacitor which are in parallel electrical connection to the liquid crystal capacitor. The first storage capacitor includes a first storage capacitor electrode which is electrically connected to the pixel electrode, a first storage-capacitor counter electrode opposing the first storage capacitor electrode, and a first dielectric layer disposed therebetween. The second storage capacitor includes a second storage capacitor electrode which is electrically connected to the pixel electrode, a second storage-capacitor counter electrode opposing the second storage capacitor electrode, and a second dielectric layer disposed therebetween.

### BACKGROUND OF THE INVENTION

1. Field of the Invention

The present invention relates to a liquid crystal display device, and in particular to an active matrix liquid crystal display device in which a storage capacitor is provided for each pixel.

2. Description of the Related Art

Liquid crystal display devices are broadly utilized in various fields because of their thinness and low power consumption. In particular, liquid crystal display devices of an active matrix type, including a thin film transistor (referred to as a “TFT”) for each pixel, have a high contrast ratio and excellent response characteristics, and are used in television sets, monitor devices, and laptop computers because of their high performance. The market scale thereof has been increasing in the recent years.

In a traditional active matrix liquid crystal display device, a storage capacitor is provided for each pixel in order to suitably retain a voltage which is applied across a liquid crystal layer for a predetermined period of time (see, for example, Japanese Laid-Open Patent Publication No. 2002-055656). FIG. 6 shows an example of a conventional active matrix liquid crystal display device having storage capacitors.

A liquid crystal display device 500 shown in FIG. 6 includes a plurality of pixels which are arranged in a matrix array. In each pixel, a liquid crystal capacitor Clc and a storage capacitor Cs which is in parallel electrical connection to the liquid crystal capacitor Clc are provided.

The liquid crystal capacitor Clc is composed of: a pixel electrode 512 which is subjected to switching by a thin film transistor 511; a counter electrode 513 opposing the pixel electrode 512; and a liquid crystal layer 514 disposed between the pixel electrode 512 and the counter electrode 513. The thin film transistor 511 receives a scanning signal from a scanning line 515, and receives a display signal from a signal line 516.

The storage capacitor Cs is composed of: a storage capacitor electrode 517 which is electrically connected to the pixel electrode 512; a storage-capacitor counter electrode 518 opposing the storage capacitor electrode 517; and a dielectric layer 519 disposed between the storage capacitor electrode 517 and the storage-capacitor counter electrode 518. The storage-capacitor counter electrode 518 is electrically connected to a storage capacitor line 529, such that a predetermined voltage is supplied from the storage capacitor line 529.

FIG. 7 and FIG. 8 show the structure of an active matrix substrate 500a which is included in the liquid crystal display device 500. FIG. 7 is a plan view schematically showing the active matrix substrate 500a. FIG. 8 is a cross-sectional view taken along line 8A-8A′ in FIG. 7. Note that FIG. 7 and FIG. 8 illustrate a top-gate type thin film transistor 511 as an example.

The active matrix substrate 500a is structured so that a plurality of conductive layers and insulating layers are stacked on a transparent insulative substrate (e.g., a glass substrate) 510. Specifically, on the insulative substrate 510, a semiconductor layer 522 of the thin film transistor 511 and a storage capacitor electrode 517 are provided, with a gate insulating film 519 being provided so to cover them. A portion of the gate insulating film 519 that is located above the storage capacitor electrode 517 functions as a dielectric layer for the storage capacitor Cs.

Above the gate insulating film 519, the scanning line 515, a gate electrode 515a extending from the scanning line 515, and the storage capacitor line 529 and the storage-capacitor counter electrode 518 are provided. As can be seen from FIG. 7, a portion of the storage capacitor line 529 that is located within the pixel functions as the storage-capacitor counter electrode 518.

An interlayer insulating film 523 is formed so as to cover the scanning line 515, the gate electrode 515a, the storage capacitor line 529, and the storage-capacitor counter electrode 518 mentioned above, and a signal line 516 is provided on the interlayer insulating film 523. The signal line 516 is connected to the semiconductor layer 522 at a contact hole 524 which is formed in the interlayer insulating film 523 and the gate insulating film 519.

A transparent resin film 526 is formed so as to cover the signal line 516, and the pixel electrode 512 is provided on the resin film 526. The pixel electrode 512 is electrically connected to the semiconductor layer 522 via a connection electrode 530 which is composed of the same conductive film as that of the signal line 516. The connection electrode 530 is connected to the semiconductor layer 522 at a contact hole 525 which is formed in the interlayer insulating film 523 and the gate insulating film 519, and connected to the pixel electrode 512 at a contact hole 527 which is formed in the interlayer insulating film 523.

As described above, the liquid crystal display device 500 includes the storage capacitor Cs which is in parallel electrical connection to the liquid crystal capacitor Clc, and therefore is able to suitably retain a voltage applied across the liquid crystal layer 514 for a predetermined period of time, thus performing high-quality displaying. In order to retain an applied voltage for a long time, it is preferable that the capacitance value of the storage capacitor Cs is large.

However, since the storage capacitor Cs includes a light-shielding member (i.e., the storage-capacitor counter electrode 518 in the illustrated construction) in its construction, providing a storage capacitor Cs with a large area to obtain an increased capacitance value will result in a decrease in the aperture ratio.

Thus, the capacitance value of a storage capacitor and the aperture ratio have a trade-off relationship, thus making it difficult to reconcile a high aperture ratio and a large capacitance value. In recent years, liquid crystal display devices are acquiring higher and higher definition, and a decrease in the aperture ratio associated with the footprint of storage capacitors is a significant problem.

### SUMMARY OF THE INVENTION

In order to solve the problems described above, preferred embodiments of the present invention provide an active matrix liquid crystal display device which has a high aperture ratio and in which storage capacitors having a sufficiently large capacitance value are provided.

A liquid crystal display device according to a preferred embodiment of the present invention includes a plurality of pixels arranged in a matrix array, each of the plurality of pixels including: a liquid crystal capacitor which includes a pixel electrode subjected to switching by a top-gate type thin film transistor, a counter electrode opposing the pixel electrode, and a liquid crystal layer disposed between the pixel electrode and the counter electrode; and a first storage capacitor and a second storage capacitor which are in parallel electrical connection to the liquid crystal capacitor, wherein, the first storage capacitor includes a first storage capacitor electrode which is electrically connected to the pixel electrode, a first storage-capacitor counter electrode opposing the first storage capacitor electrode, and a first dielectric layer which is disposed between the first storage capacitor electrode and the first storage-capacitor counter electrode; the second storage capacitor includes a second storage capacitor electrode which is electrically connected to the pixel electrode, a second storage-capacitor counter electrode opposing the second storage capacitor electrode, and a second dielectric layer which is disposed between the second storage capacitor electrode and the second storage-capacitor counter electrode; the first storage-capacitor counter electrode and the second storage-capacitor counter electrode are a single electrode which is common to the first storage capacitor and the second storage capacitor; the first dielectric layer is a portion of a gate insulating film covering a semiconductor layer of the thin film transistor; and the second dielectric layer is a portion of an interlayer insulating film covering a scanning line arranged to supply a scanning signal to the thin film transistor, and is a selectively thin-filmed portion which is made thinner than any other portion of the interlayer insulating film.

In a preferred embodiment, the first storage capacitor electrode includes a same semiconductor film as that of the semiconductor layer of the thin film transistor.

In a preferred embodiment, the second storage capacitor electrode includes a same conductive film as that of a signal line arranged to supply a display signal to the thin film transistor.

In a preferred embodiment, the liquid crystal display device according to the present invention further includes a resin film covering the signal line and the second storage capacitor electrode, wherein the pixel electrode is formed on the resin film.

In a preferred embodiment, the interlayer insulating film is a multilayer insulating film in which a first layer and a second layer including respectively different insulative materials are stacked; the multilayer insulating film has a low-stack region where the second layer is selectively removed; and the second dielectric layer of the second storage capacitor is the low-stack region of the multilayer insulating film.

A liquid crystal display device according to a preferred embodiment of the present invention is a liquid crystal display device of an active matrix type which is driven by top-gate type thin film transistors, and for each pixel, includes two storage capacitors (a first storage capacitor and a second storage capacitor) which are in parallel electrical connection to a liquid crystal capacitor. Each storage capacitor includes a storage capacitor electrode which is electrically connected to a pixel electrode, a storage-capacitor counter electrode opposing the storage capacitor electrode, and a dielectric layer disposed between the storage capacitor electrode and the storage-capacitor counter electrode.

In the liquid crystal display device according to a preferred embodiment of the present invention, the storage-capacitor counter electrodes of the two storage capacitors is a single electrode which is common to both storage capacitors. In other words, the two storage capacitors are provided in a vertically overlying relationship. As a result, the value of the storage capacitor can be increased without much increase in the footprint of the storage capacitor.

Moreover, a dielectric layer of the one storage capacitor (i.e., the first dielectric layer of the first storage capacitor) is a portion of a gate insulating film covering the semiconductor layer of the thin film transistor, whereas a dielectric layer of the other storage capacitor (i.e., the second dielectric layer of the second storage capacitor) is a portion of an interlayer insulating film covering the scanning line, and further is a selectively thin-filmed portion which is made thinner than any other portion of the interlayer insulating film. Therefore, in the liquid crystal display device according to a preferred embodiment of the present invention, the capacitance value of the second storage capacitor can be increased without increasing the parasitic capacitance which is formed between wiring lines which oppose each other via the interlayer insulating film, whereby bright and high-quality displaying can be realized.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an equivalent circuit diagram schematically showing a liquid crystal display device 100 according to a preferred embodiment of the present invention.

FIG. 2 is a plan view schematically showing an active matrix substrate 100a of the liquid crystal display device 100.

FIGS. 3A and 3B are cross-sectional views schematically showing the active matrix substrate 100a of the liquid crystal display device 100, wherein FIG. 3A shows a cross section taken along line 3A-3A′ in FIG. 2, and FIG. 3B shows a cross section taken along line 3B-3B′ in FIG. 2.

FIG. 4 is a diagram for explaining a method of selectively making a portion of an interlayer insulating film 23 of the active matrix substrate 100a into a thin film.

FIG. 5 is a cross-sectional view schematically showing an active matrix substrate 100a having an interlayer insulating film 23 of a multilayered structure.

FIG. 6 is an equivalent circuit diagram schematically showing a conventional liquid crystal display device 500 having storage capacitors.

FIG. 7 is a plan view schematically showing an active matrix substrate 500a of the liquid crystal display device 500.

FIG. 8 is a cross-sectional view schematically showing the active matrix substrate 500a of the liquid crystal display device 500, showing a cross section taken along line 8A-8A′ in FIG. 7.

### DETAILED DESCRIPTION OF THE PREFERRED EMBODIMENTS

Hereinafter, preferred embodiments of the present invention will be described with reference to the drawings. Note that the present invention is not limited to the following preferred embodiments.

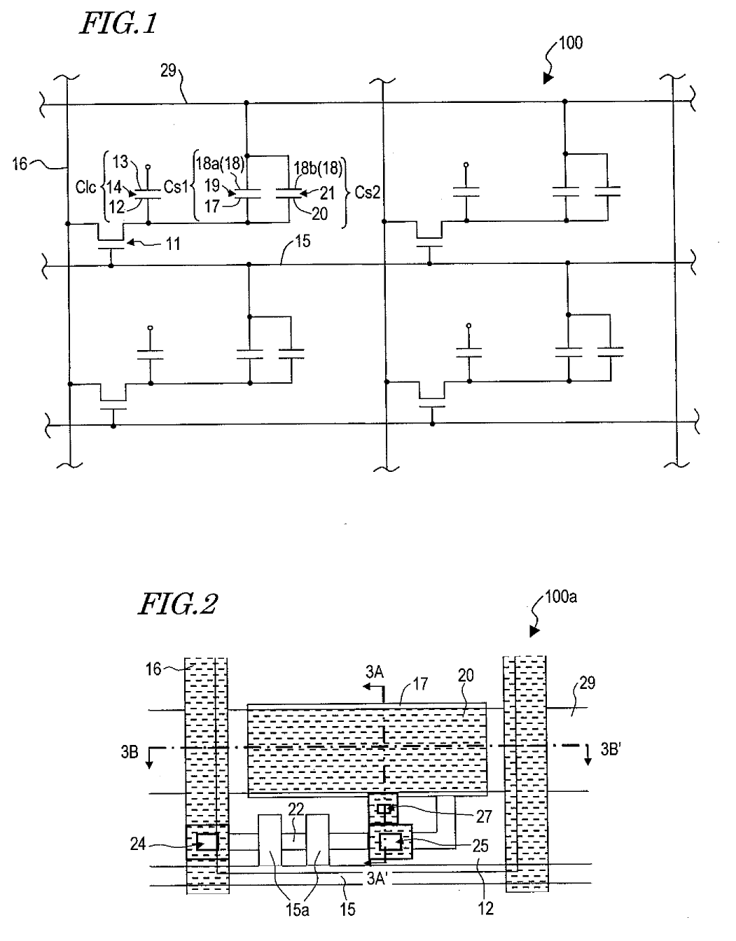

FIG. 1 schematically shows an equivalent circuit of the liquid crystal display device 100 according to a preferred embodiment of the present invention. As shown in FIG. 1, the liquid crystal display device 100 includes a plurality of pixels which are arranged in a matrix array. In each pixel, a liquid crystal capacitor Clc and a first storage capacitor Cs1 and a second storage capacitor Cs2, which are in parallel electrical connection to the liquid crystal capacitor Clc, are provided.

The liquid crystal capacitor Clc includes: a pixel electrode 12 which is subjected to switching by a thin film transistor 11; a counter electrode 13 opposing the pixel electrode 12; and a liquid crystal layer 14 disposed between the pixel electrode 12 and the counter electrode 13. The thin film transistor 11 receives a scanning signal from a scanning line 15 and a display signal from a signal line 16. The thin film transistor 11 preferably is a top-gate type, as will be specifically described later.

The first storage capacitor Cs1 includes: a first storage capacitor electrode 17 which is electrically connected to the pixel electrode 12; a first storage-capacitor counter electrode 18a opposing the first storage capacitor electrode 17; and a first dielectric layer 19 disposed between the first storage capacitor electrode 17 and the first storage-capacitor counter electrode 18a.

The second storage capacitor Cs2 includes: a second storage capacitor electrode 20 which is electrically connected to the pixel electrode 12; a second storage-capacitor counter electrode 18b opposing the second storage capacitor electrode 20; and a second dielectric layer 21 disposed between the second storage capacitor electrode 20 and the second storage-capacitor counter electrode 18b.

The first storage-capacitor counter electrode 18a and the second storage-capacitor counter electrode 18b are electrically connected to a storage capacitor line 29, such that a predetermined voltage is supplied from the storage capacitor line 29.

The first storage-capacitor counter electrode 18a and the second storage-capacitor counter electrode 18b are separately illustrated in the equivalent circuit shown in FIG. 1. However, in the liquid crystal display device 100 of the present preferred embodiment, the first storage-capacitor counter electrode 18a and the second storage-capacitor counter electrode 18b are a single electrode which is common to the first storage capacitor Cs1 and the second storage capacitor Cs2. Hereinafter, this common electrode will be also referred to as a “common storage-capacitor counter electrode”.

Specifically, the first dielectric layer 19 of the first storage capacitor Cs1 is a portion of a gate insulating film that covers the semiconductor layer of the thin film transistor 11. On the other hand, the second dielectric layer 21 of the second storage capacitor Cs2 is, specifically, a portion of an interlayer insulating film covering the scanning line 15, and more specifically, a selectively thin-filmed portion which is made thinner than any other portion.

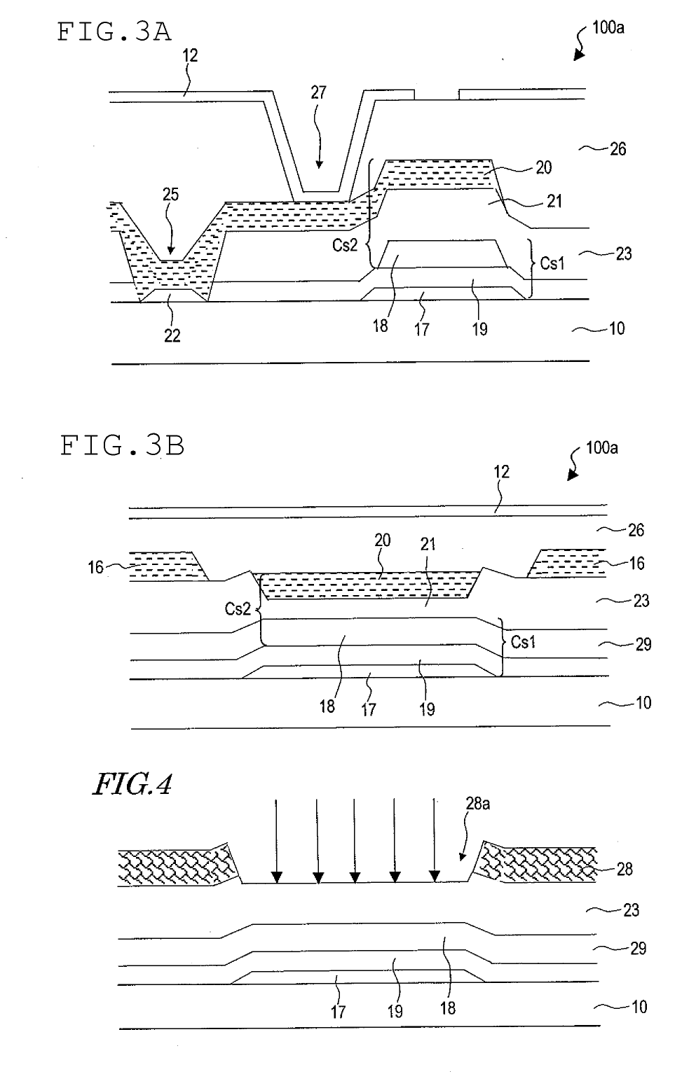

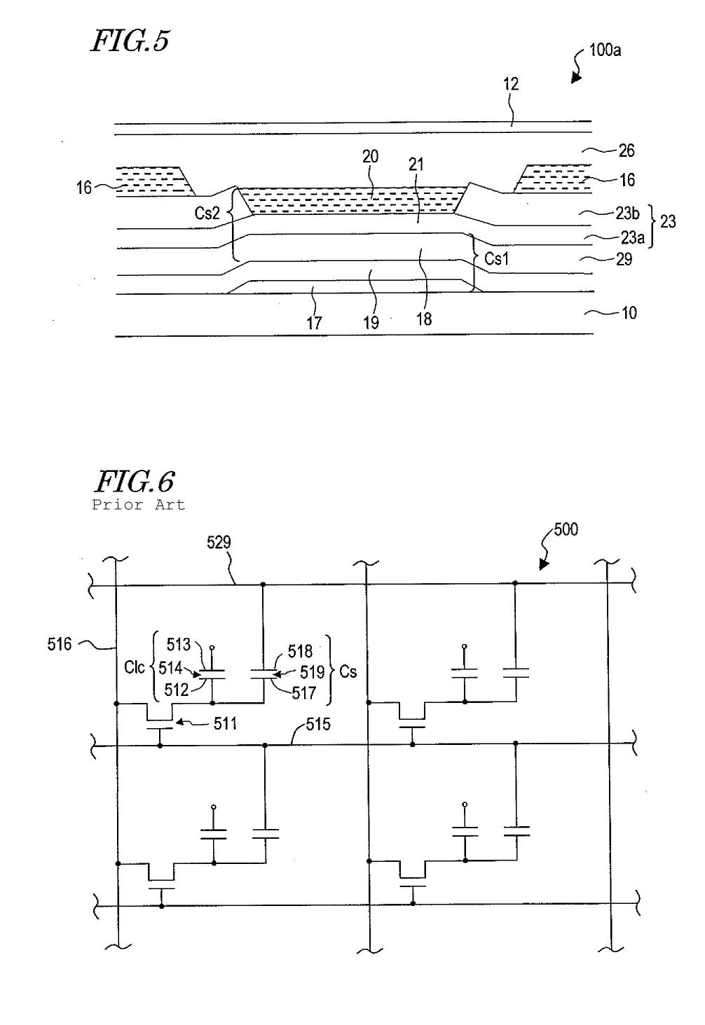

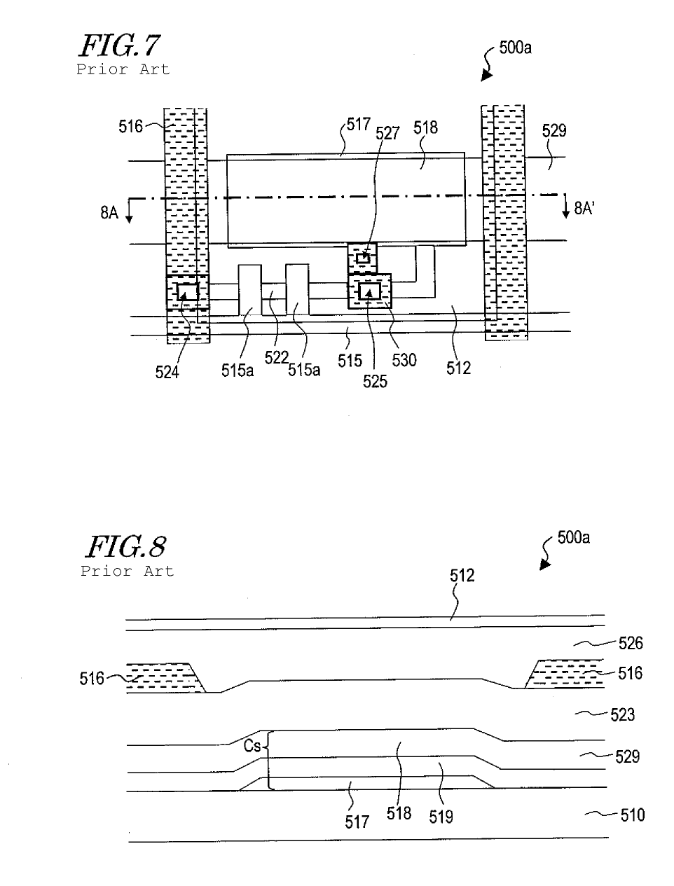

Hereinafter, with reference to FIG. 2 and FIGS. 3A and 3B, the structure of the liquid crystal display device 100 will be described more specifically. FIG. 2 is a plan view schematically showing the structure of an active matrix substrate 100a of the liquid crystal display device 100. FIG. 3A is a cross-sectional view taken along line 3A-3A′ in FIG. 2, whereas FIG. 3B is a cross-sectional view taken along line 3B-3B′ in FIG. 2.

The active matrix substrate 100a has a structure in which a plurality of conductive layers and insulating layers are stacked on a transparent insulative substrate (e.g., a glass substrate) 10. Specifically, a semiconductor layer (e.g., an n⁺-Si layer) 22 and the first storage capacitor electrode 17 are first provided on the insulative substrate 10, and the gate insulating film 19 is provided so as to cover them. The portion of the gate insulating film 19 that is located above the first storage capacitor electrode 17 functions as the first dielectric layer 19 of the first storage capacitor Cs1. The first storage capacitor electrode 17 is defined by at least a portion of the same semiconductor film as that of the semiconductor layer 22 of the thin film transistor 11. As can also be seen from FIG. 2, the first storage capacitor electrode 17 is extended from the semiconductor layer 22, and is electrically connected to the pixel electrode 12 via the semiconductor layer 22.

On the gate insulating film 19, the scanning line 15, a gate electrode 15a extended from the scanning line 15, the storage capacitor line 29, and the common storage-capacitor counter electrode 18 are provided. These are preferably made up of the same conductive film. As can be seen from FIG. 2, a portion of the storage capacitor line 29 that is located within the pixel functions as the common storage-capacitor counter electrode 18.

An interlayer insulating film 23 is provided so as to cover the scanning line 15, the gate electrode 15a, the storage capacitor line 29, and the common storage-capacitor counter electrode 18 mentioned above. As shown in FIG. 3B, the interlayer insulating film 23 includes the selectively thin-filmed portion 21 (which is made thinner than any other portion) above the common storage-capacitor counter electrode 18, the portion 21 functioning as the second dielectric layer 21 of the second storage capacitor Cs2.

The signal line 16 is provided on the interlayer insulating film 23. The signal line 16 is connected to the semiconductor layer 22 at a contact hole 24 which is formed in the interlayer insulating film 23 and the gate insulating film 19. Moreover, the second storage capacitor electrode 20 is provided above the thin-filmed portion of the interlayer insulating film 23 (i.e., the second dielectric layer composing the second storage capacitor Cs2) 21. The second storage capacitor electrode 20 is preferably defined by at least a portion of the same conductive film as that of the signal line 16. The second storage capacitor electrode 20 is connected to the semiconductor layer 22 at a contact hole 25 which is formed in the gate insulating film 19 and the interlayer insulating film 23 on the semiconductor layer 22.

A transparent resin film 26 is formed so as to cover the signal line 16 and the second storage capacitor electrode 20, and a pixel electrode (composed of, e.g., ITO) 12 is provided on the resin film 26. The pixel electrode 12 is connected to the second storage capacitor electrode 20 at a contact hole 27 which is formed in the interlayer insulating film 23. Providing the resin film 26 permits the pixel electrode 12 to overlie the thin film transistor 11 and the wiring lines, whereby the aperture ratio is improved.

As described above, the liquid crystal display device 100 of the present preferred embodiment includes the first storage capacitor Cs1 and the second storage capacitor Cs2, which are in parallel electrical connection to the liquid crystal capacitor Clc. The first storage-capacitor counter electrode 18a of the first storage capacitor Cs1 and the second storage-capacitor counter electrode 18b of the second storage capacitor Cs2 are one common electrode 18, such that the first storage capacitor Cs1 and the second storage capacitor Cs2 are provided in a vertically overlying relationship. Therefore, in accordance with the liquid crystal display device 100 of the present preferred embodiment, it is possible to increase the value of each storage capacitor without increasing the footprint of the storage capacitor. As a result, a high aperture ratio and a sufficiently large storage capacitance value can be realized.

Moreover, in accordance with the liquid crystal display device 100 of the present preferred embodiment, the second dielectric layer 21 of the second storage capacitor Cs2 is a selectively thin-filmed portion of the interlayer insulating film 23. Therefore, the capacitance value of the second storage capacitor Cs2 can be increased, without increasing the capacitance which is created between wiring lines (called “parasitic capacitance”, which unfavorably affects displaying) that oppose each other via the interlayer insulating film 23 (e.g. between the scanning line 15 and the signal line 16, and between the storage capacitor line 29 and the signal line 16). Therefore, bright and high-quality displaying is realized.

As a technique of selectively thin-filming a portion of the interlayer insulating film 23, etching can be used, for example. As shown in FIG. 4, a resist film 28 having an aperture 28a in a portion overlying the common storage-capacitor counter electrode 18 may be formed on the interlayer insulating film 23, and by etching a portion of the interlayer insulating film 23 while using the resist film 28 as a mask, the thin-filmed second dielectric layer 21 can be formed.

Moreover, in some traditional liquid crystal display devices, a portion of the pixel electrode may be utilized as a storage capacitor electrode composing the storage capacitor. However, in accordance with the liquid crystal display device 100 of the present preferred embodiment, the pixel electrode 12 is not utilized as a storage capacitor electrode composing the storage capacitor. Specifically, the first storage capacitor electrode 17 of the first storage capacitor Cs1 is a layer preferably defined by at least a portion of the same semiconductor film as that of the semiconductor layer 22, and the second storage capacitor electrode 20 of the second storage capacitor Cs2 is a layer preferably defined by at least a portion of the same conductive film as that of the signal line 16. Both of these are separately formed electrodes from the pixel electrode 12.

In the case where a portion of the pixel electrode is utilized as the storage capacitor electrode, it is impossible to provide the pixel electrode on a thick resin film. Therefore, the planarity of the active matrix substrate is likely to become poorer, thus making it difficult to control the cell thickness. Moreover, it is also impossible to allow the pixel electrode to overlie the thin film transistor or wiring lines, whereby the aperture ratio is deteriorated.

On the other hand, in accordance with liquid crystal display device 100 of the present preferred embodiment, the pixel electrode 12 is not utilized as the storage capacitor electrode, thus making it possible to provide the pixel electrode 12 on a thick (specifically, about 2.0 μm or more) resin film 26. Therefore, it is easy to ensure planarity of the active matrix substrate 100a, and it is easy to control the cell thickness. Since the pixel electrode 12 may overlie the thin film transistor 11 and wiring lines, a high aperture ratio can be obtained, too.

Although FIG. 3 illustrates a single-layered interlayer insulating film 23, the interlayer insulating film 23 may be a multilayer insulating film 23 in which a plurality of layers 23a and 23b are stacked, as shown in FIG. 5. The multilayer insulating film 23 shown in FIG. 5 includes the first layer 23a and the second layer 23b, which preferably include respectively different insulative materials. The first layer 23a is, e.g., an SiNx layer (having a relative dielectric constant of 6.8). The second layer 23b formed on the first layer 23a is, e.g., an SiO₂ layer (having a relative dielectric constant of 3.8). The second layer 23b is removed from over the common storage-capacitor counter electrode 18, thus leaving a low-stack region 21 where the second layer 23b is selectively removed; the low-stack region 21 functions as the second dielectric layer 21 of the second storage capacitor Cs2.

Using the interlayer insulating film 23 having a multilayered structure makes it possible, when selectively thinning a portion of the interlayer insulating film 23 via etching (thin-filming), to utilize the first layer 23a (the lower layer) as an etch stop layer, by taking advantage of a difference in etching rate between the first layer 23a and the second layer 23b. Therefore, variations in the thickness of the second dielectric layer 21 can be reduced, and variations in the storage capacitor value can be reduced.

The materials of the first layer 23a and the second layer 23b composing the multilayer insulating film 23 are not limited to those exemplified here. However, from the standpoint of increasing the capacitance value of the second storage capacitor Cs2, it is preferable to use a material which has a higher relative dielectric constant than that of the second layer 23b (upper layer) as the material of the first layer 23a (lower layer).

According to preferred embodiments of the present invention, there is provided an active matrix liquid crystal display device which has a high aperture ratio and in which storage capacitors having a sufficiently large capacitance value are provided.

Preferred embodiments of the present invention may be suitably used for various active matrix liquid crystal display devices. A particularly advantageous effect is obtained when preferred embodiments of the present invention are used for a high-resolution liquid crystal display device.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-5. (canceled)

6. A liquid crystal display device comprising:
a plurality of pixels arranged in a matrix array, each of the plurality of pixels including:
a liquid crystal capacitor which includes a pixel electrode arranged to be switched by a top-gate type thin film transistor, a counter electrode opposing the pixel electrode, and a liquid crystal layer disposed between the pixel electrode and the counter electrode; and
a first storage capacitor and a second storage capacitor which are in parallel electrical connection to the liquid crystal capacitor; wherein
the first storage capacitor includes a first storage capacitor electrode which is electrically connected to the pixel electrode, a first storage-capacitor counter electrode opposing the first storage capacitor electrode, and a first dielectric layer which is disposed between the first storage capacitor electrode and the first storage-capacitor counter electrode;
the second storage capacitor includes a second storage capacitor electrode which is electrically connected to the pixel electrode, a second storage-capacitor counter electrode opposing the second storage capacitor electrode, and a second dielectric layer which is disposed between the second storage capacitor electrode and the second storage-capacitor counter electrode;
the first storage-capacitor counter electrode and the second storage-capacitor counter electrode are a single electrode which is common to the first storage capacitor and the second storage capacitor;
the first dielectric layer is a portion of a gate insulating film covering a semiconductor layer of the thin film transistor; and
the second dielectric layer is a portion of an interlayer insulating film covering a scanning line arranged to supply a scanning signal to the thin film transistor, and is a selectively thin-filmed portion which is made thinner than any other portion of the interlayer insulating film.

7. The liquid crystal display device of claim 6, wherein the first storage capacitor electrode includes a same semiconductor film as that of the semiconductor layer of the thin film transistor.

8. The liquid crystal display device of claim 6, wherein the second storage capacitor electrode includes a same conductive film as that of a signal line arranged to supply a display signal to the thin film transistor.

9. The liquid crystal display device of claim 7, wherein the second storage capacitor electrode includes a same conductive film as that of a signal line arranged to supply a display signal to the thin film transistor.

10. The liquid crystal display device of claim 8, further comprising a resin film covering the signal line and the second storage capacitor electrode, wherein the pixel electrode is formed on the resin film.

11. The liquid crystal display device of claim 9, further comprising a resin film covering the signal line and the second storage capacitor electrode, wherein the pixel electrode is formed on the resin film.

12. The liquid crystal display device of claim 6, wherein,
the interlayer insulating film is a multilayer insulating film in which a first layer and a second layer including respectively different insulative materials are stacked;
the multilayer insulating film has a low-stack region where the second layer is selectively removed; and
the second dielectric layer of the second storage capacitor is the low-stack region of the multilayer insulating film.

13. The liquid crystal display device of claim 7, wherein,
the interlayer insulating film is a multilayer insulating film in which a first layer and a second layer including respectively different insulative materials are stacked;
the multilayer insulating film has a low-stack region where the second layer is selectively removed; and
the second dielectric layer of the second storage capacitor is the low-stack region of the multilayer insulating film.

14. The liquid crystal display device of claim 8, wherein,
the interlayer insulating film is a multilayer insulating film in which a first layer and a second layer including respectively different insulative materials are stacked;
the multilayer insulating film has a low-stack region where the second layer is selectively removed; and
the second dielectric layer of the second storage capacitor is the low-stack region of the multilayer insulating film.

15. The liquid crystal display device of claim 9, wherein,
the interlayer insulating film is a multilayer insulating film in which a first layer and a second layer including respectively different insulative materials are stacked;
the multilayer insulating film has a low-stack region where the second layer is selectively removed; and
the second dielectric layer of the second storage capacitor is the low-stack region of the multilayer insulating film.

16. The liquid crystal display device of claim 10, wherein,
the interlayer insulating film is a multilayer insulating film in which a first layer and a second layer including respectively different insulative materials are stacked;
the multilayer insulating film has a low-stack region where the second layer is selectively removed; and
the second dielectric layer of the second storage capacitor is the low-stack region of the multilayer insulating film.

17. The liquid crystal display device of claim 11, wherein,
the interlayer insulating film is a multilayer insulating film in which a first layer and a second layer including respectively different insulative materials are stacked;
the multilayer insulating film has a low-stack region where the second layer is selectively removed; and
the second dielectric layer of the second storage capacitor is the low-stack region of the multilayer insulating film.
